(19) United States
(12) Patent Application Publication
(10) Pub. No.: US 2012/0254925 A1
(43) Pub. Date: Oct. 4, 2012

(54) COMPUTER SYSTEMS AND METHODS FOR VIDEO CAPTURING, MANAGING, AND/OR SHARING

(75) Inventor: Justin Matthew Nassiri, San Francisco, CA (US)

(73) Assignee: VideoGenie, Inc., Palo Alto, CA (US)

(21) Appl. No.: 13/078,719

(22) Filed: Apr. 1, 2011

(51) Int. Cl. H04N 7/173

(52) U.S. Cl. 725/92

(57) ABSTRACT

Examples are described for capturing, managing, and/or sharing videos. The videos may be captured such that they are limited in time, such as 30 seconds or less in some examples. Enterprises may establish campaigns and capture videos associated with the campaigns. Captured videos may be displayed to users in an order selected based on the number of hits or conversions the video had previously generated. A host video system may provide embedded code for video capture and playback on an enterprise site.

### TECHNICAL FIELD

Embodiments of the invention relate generally to computer systems, and particularly, computer systems and methods for video capturing, managing, and/or sharing.

### BACKGROUND

The viewing of videos available on the Internet has been steadily increasing. Sites such as YouTube allow users to upload videos that can then easily be viewed by others over the Internet. The sites allow users to post their videos and other users may search the site to locate and view the posted videos.

Moreover, people are increasingly utilizing social media sites to gain information about the world around them. Facebook, for example, allows users to set up an account and follow or “like” a business. In this manner, business may send advertisements, deals, or news updates to users who have indicated they would like to receive that information. Each Facebook user may be connected to their own network of friends, and a business' advertisements and notifications may also be seen by the user's network of friends, broadening the distribution.

### BRIEF DESCRIPTION OF THE DRAWINGS

FIG. 1 is a schematic illustration of a system in accordance with an embodiment of the present invention.

FIG. 2 is a flowchart of an example method for capturing videos in accordance with an embodiment of the present invention.

FIG. 3 is a schematic illustration of a display in accordance with an embodiment of the present invention.

FIG. 4 is a schematic illustration of another display in accordance with an embodiment of the present invention.

FIG. 5 is a schematic illustration of a system arranged in accordance with an embodiment of the present invention.

FIG. 6 is a flowchart of an example method for managing videos in accordance with an embodiment of the present invention.

FIG. 7 is a schematic illustration of a display in accordance with an embodiment of the present invention.

FIG. 8 is a schematic illustration of a system in accordance with an embodiment of the present invention.

FIG. 9 is a flowchart of an example method for sharing videos in accordance with an embodiment of the present invention.

FIG. 10 is a schematic illustration of information associated with videos which may be stored in examples of the present invention.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known computer system components, software operations, user interface elements, circuits, and control signals have not been shown in detail in order to avoid unnecessarily obscuring the described embodiments of the invention.

Examples of the present invention include computer systems, computer readable media, and methods for video capturing, managing, and/or sharing. Examples of the invention may advantageously allow enterprises, in a scalable manner, to obtain authentic marketing materials from customers or other individuals. In particular, promotional videos may be received directly from customers or other individuals. The enterprises may then manage the received videos, for example, by approving or disapproving submitted videos. The enterprise may then share the videos with others in a variety of ways. Embodiments of the present invention may facilitate video capture, management, and/or sharing. Embodiments of the present invention may accordingly increase customer ‘conversion’ events. That is, a potential customer viewing videos that have been captured, managed, and/or shared in accordance with embodiments of the present invention may be more likely to take an action favorable to the enterprise—such as by signing up for a newsletter or other mailing offered by the enterprise, purchasing something from the enterprise, telling others about the enterprise, spending more time on the enterprise's website or storefront, or other conversion action. Video, as used herein, generally refers to electronically encoded data representing a captured video and/or audio data. The videos may generally be transmitted and stored in any suitable file format, including but not limited to, .mpeg files, or .avi files.

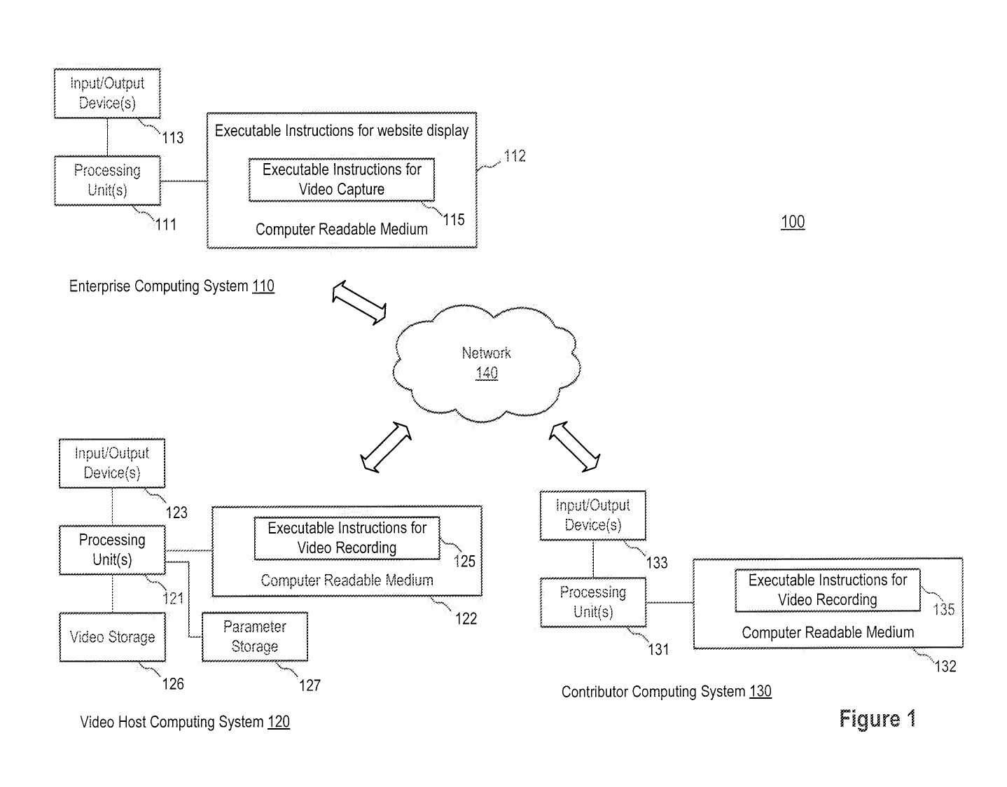

FIG. 1 is a schematic illustration of a system in accordance with an embodiment of the present invention. The system 100 may include an enterprise computing system 110, a video host computing system 120, and a contributor computing system 130. The system 100 shown in FIG. 1 shows components, all or combinations of which, may be used in examples of the invention for capturing videos. The computing systems may be in communication over one or more networks, wired or wireless, such as the network 140 shown in FIG. 1. Generally, the components included in each of the computing systems 110, 120, and 130 is quite flexible. Each of the computing systems generally may include one or more processing unit(s) 111, 121, 131. Substantially any type of processing unit may be used, including processors of any kind or type. Each of the computing systems generally may also include one or more computer readable medium 112, 122, 132 that encodes executable instructions. Substantially any type of computer readable medium may be used including, but not limited to, RAM, ROM, hard disk storage, flash memory, optical storage, or combinations thereof. The encoded executable instructions may operate in cooperation with the processing unit(s) to perform the functions described herein. Input and/or output device(s) 113, 123, 133 may also be included to allow for input and output. Examples of input and/or output devices include, but are not limited to, display devices, keyboards, mice, cameras, video cameras, webcams, touch screens, or combinations thereof. While three distinct computing systems 110, 120, and 130 are shown in FIG. 1 it is to be understood in some examples, one computing system may perform the functions described of any combination of the computing systems shown. That is, the division shown in FIG. 1 is exemplary only. Moreover, the computing systems may have substantially any form factor. The computing systems may be implemented as any of a variety of devices including, but not limited to, server systems, desktops, laptops, kiosks, mobile phones, personal digital assistants, set top boxes, appliances, or combinations thereof.

The enterprise computing system 110 may be a computing system operated by an enterprise that may want to capture, manage, and/or share videos in accordance with embodiments of the present invention. Examples of enterprises include, but are not limited to, businesses (having traditional storefronts and/or web presences), government agencies, or any other entity. The enterprise computing system 110 may include one or more computer readable medium 112 encoded with executable instructions for website display that operate in cooperation with the processing unit(s) 111 to display a website associated with the enterprise. The enterprise computing system 110 may accordingly be implemented as all or a portion of a web server system. The executable instructions for website display may display any webpage associated with the enterprise, including but not limited to, informational pages, purchasing pages, or combinations thereof. The executable instructions for website display in some examples may not be limited to the display of websites in a traditional Internet browser, but may transmit content over the network 140 for display in substantially any application.

The executable instructions for website display may including executable instructions for video capture 115. The executable instructions for video capture 115 may provide the functionality of a video recorder, and may or may not be embedded within the executable instructions for website display. In some examples, the executable instructions for video capture 115 may be separate from the executable instructions for website display. In some examples, the executable instructions for video capture 115 include a link to a separate video capture page. The video capture page may be hosted, for example, by the video host computing system 120. In this manner, a user accessing the website or other content delivered by the executable instructions for website display may follow a link to a video capture page hosted by the video host computing system 120. The link may, in some examples, be provided in a page of or otherwise integrated with other information provided by the enterprise computing system 110. In this manner, a user may not know they are being redirected to the video host computing system 120 for video capture. As will be described further below, the link provided by the executable instructions for video capture may be generated by the video host computing system 120 for a particular enterprise and/or for a particular video campaign. That is, the URL or other network location specified by the link may be unique to a particular enterprise. In some examples, the URL or other network location specified by the link may be unique to a particular video campaign, which may be sponsored by a particular enterprise or may be sponsored by a group of enterprises.

In other examples, the executable instructions for video capture 115 may include executable instructions for an embedded video recorder. For example, an HTML iframe may be used to embed a video recorder in a web page provided by the enterprise computing system 110. The iframe may point users to the video host computing system 120. One example of iframe code that may be used to embed a video recorder is: <iframe style=“height:460px; width:820px; border:0px” border=0 frameborder=0 width=“820” height=“460” src=http://record.videogenie.com/media/?uid=123A45B6789C00D12E></iframe>. In this example code, note that an administrator may specify the height, width, and border associated with the video recorder. Similar to the standalone link example described above, the iframe generated on the website points a user to another site, in this example a site hosted by the video host computing system 120, however, it may appear within the context of a web page or other content hosted by the enterprise computing system 110 using the iframe. The URL used in the iframe may be generated by the video host computing system 120 in the manner generally described above.

Embodiments of the video host computing system 120 accordingly may include executable instructions for video recording 125 encoded on one or more computer readable media 122. The video host computing system 120 may be a computing system operated by an entity serving as a video host. The entity may service one or more enterprise computing systems, such as the enterprise computing system 120 shown in FIG. 1. The video host computing system 120 may receive and store videos from any number of contributor computing systems 130 which may be solicited by one or more of the enterprise computing systems in accordance with campaigns or accounts, as will be described further below. The executable instructions for video recording 125 may be accessed by way of the executable instructions for video capture 115, as described above.

The executable instructions for video recording 125 may operate in cooperation with the processing unit(s) 121 to provide a video recorder functionality. That is, the executable instructions for video recording 125 may allow the video host computing system 120 to provide video recorder functionality that may be accessed by one or more users, such as the contributor computing system 130. The executable instructions for video recording 125 may further include instructions for receiving a completed video and storing the video in storage accessible to the video host computing system 120, such as the video storage 126.

The executable instructions for video recording 125 may include instructions for limiting the availability of the video recording function by time. In particular, examples of the executable instructions for video recording 125 may limit the length of the video a contributor may be able to record. In some examples, the length of the video may be limited to 30 seconds or less, in some examples, 25 seconds or less, in some examples, 20 seconds or less, in some examples 15 seconds or less, and in some examples 10 seconds or less. Examples of the present invention may advantageously limit the length of videos which may be captured because limiting the length of video may advantageously result in the capture of videos which are more salient to the enterprise. That is, as will be described further below, an enterprise may solicit videos on a particular topic, such as recommending or commenting on their business or product. By limiting the length of videos which may be recorded, higher quality videos may be captured that require little or, in some examples, no editing. This may advantageously increase the quality of videos collected for a video campaign. The limit on video length may be hard coded into the executable instructions for video recording 125 in some examples. In some examples, the length of video which may be captured by the executable instructions for video recording 125 may be stored in parameter storage 127 accessible to the processing unit(s) 121. The length may be specified by the enterprise computing system 110 for all campaigns operated by the enterprise, or for individual campaigns. The length may vary between campaigns, with longer videos allowed for some campaigns than others. Accordingly, the executable instructions for video recording 125 may operate in accordance with the processing unit(s) 121 to access the parameter storage 127, determine a maximum length of video to be recorded, and limit the recording time to the maximum length.

Other examples of parameters which may be stored in the parameter storage 127 include a prompt related to a particular campaign established by one or more enterprises, as will be described further below. Examples of prompts include, but are not limited to, questions, phrases, instructions, images, and combinations thereof. One prompt may be “How do you like our business?”, for example. Any number of prompts may be used. The executable instructions for video recording 125 may include instructions for accessing the parameter storage 127, determining a prompt to use, and transmitting the prompt to the contributor computing system 130 for display to a contributor before or during the recording of video. In this manner, the prompt is visible to the contributor prior to or during video recording such that their recorded content is more likely to be related to or responsive to the prompt.

Examples of the executable instructions for video recording 125 may further include executable instructions for timing. The executable instructions for timing may display for a video contributor a timer showing the maximum amount of time available. The timer may count down as time elapses, so a contributor recording a video may visually see the amount of time remaining to record. In this manner, the timer may serve as a constraint on the video content received from a contributor. In some examples, the timer may visually count up until the predetermined maximum duration is reached. When the maximum time elapses, the video recording functionality may be halted, and no more video from the contributor may be captured.

Embodiments of the contributor computing system 130 accordingly may include a computer readable medium 132 storing executable instructions for video capture display. The contributor computing system 130 may be a computing system operated by one or more entities who may contribute a video in accordance with examples of the present invention. Contributing entities may include individual users, such as customers or fans of an enterprise hosting the enterprise computing system 110. While shown as a separate computing system 130 in FIG. 1, in some examples, the enterprise computing system 110 may include the components of the contributor computing system 130 shown in FIG. 1.

The computer readable medium 132 may operate in cooperation with the processing unit(s) 131 to provide an Internet browser or other content display application that may request content from the enterprise computing system 110. Accordingly, the contributor computing system 130 may access a website or other content provided by the enterprise computing system 110, including the embedded or standalone link provided by the executable instructions for video capture 115. A video recorder accessible through the embedded or standalone link may be displayed on an input/output device 133. A user may follow the embedded or standalone link and utilize the video recorder functionality provided by the executable instructions for video recording 125. The timer may also be displayed on an input/output device 133, illustrating the amount of time available to contributor. Once the maximum time has elapsed, as described above, the video recorder functionality may halt in accordance with the executable instructions for video recording 125 and the contributor in some examples may receive a message or other notification indicating that the time has elapsed.

The executable instructions for video recording 125 may in some examples provide feedback to the contributor computing system 130. Examples of feedback may include an indication of whether the audio being recorded is too loud or too soft, and an indication of whether the lighting being used is too bright or too dim. Accordingly, as the video host computing system 120 receives video data from the contributor computing system 130, the executable instructions for video recording 125 may include instructions for comparing the volume and/or the visual aspects of the data, including but not limited to brightness or contrast, with a threshold condition. The threshold may be stored in the parameter storage 127, for example. If the received video data quality does not meet the threshold, the executable instructions for video recording may transmit feedback data to the contributor computing system for display to a contributor. For example, a light or other indicator may be displayed prompting the contributor to use more or less lighting, or to speak louder or softer. In other examples, a message may be displayed to the contributor, such as “speak louder” or “increase lighting.”

The video generated using the video recorder may be transmitted to the video host computing system 120 for storage in video storage 126. In some examples, the video may be transmitted to the video host computing system while it is being recorded in accordance with the executable instructions for video recording 125. In other examples, the video may be transmitted to the video host computing system after it has been recorded and/or reviewed by a user of the contributor computing system 130.

Having described an example of a system suitable for use in capturing videos, examples of methods of capturing videos will now be described. The methods may make use of some or all of the components shown in FIG. 1.

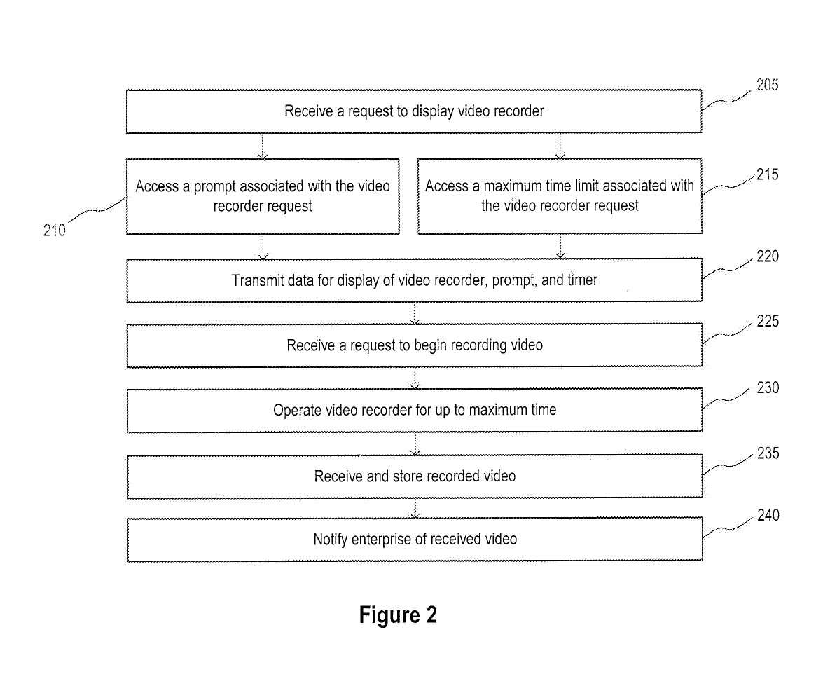

FIG. 2 is a flowchart of an example method for capturing videos in accordance with an embodiment of the present invention. In block 205, a request may be received to display or otherwise access a video recorder. As was described above, the request may be a request initiated by a contributor to access a standalone video recorder site. The contributor may make the request by, for example, clicking on a link displayed on another of the enterprise's sites or content providing applications. In some examples, the contributor may have received the link in a card, email, or other promotional material sent by the enterprise. For example, after making a purchase, a purchaser may receive a link to access the video recorder, and may, in some examples, see a prompt asking them to describe their experience. In other examples, the request may come from an enterprise in accordance with embedded code in another of the enterprise's sites or content providing applications. Referring back to FIG. 1, the request may accordingly be initiated by the contributor computing system 130 in some examples or the enterprise computing system 110 in other examples. The request may be received by the video host computing system 120.

In block 210, a prompt associated with the received request may be accessed. Similarly, in block 215, a maximum time limit associated with the received request may be accessed. In some examples, both a prompt and a time limit associated with the received request may be accessed. In other examples, only one of a prompt or a time limit is accessed. In some examples, neither may be accessed. As was described above with reference to FIG. 1, the video host computing system 120 may access the prompt, the time limit, or both, from parameter storage 127. The received request may contain information associating the request with a particular time limit and/or request. This association may be made in any of a variety of ways. For example, the URL or other link provided to a contributor, either as a standalone or as an embedded link, may contain information about the enterprise and/or the particular campaign for which video is requested. Recall, as described above, that the URL or other content link may be generated by the video host computing system. The URL itself may contain a string of characters which identifies the request as pertaining to a particular enterprise, and/or a particular campaign. In some examples, the URL or other content link itself may contain information about the maximum time limit and/or the prompt to be used. In this manner, in blocks 210 and 215, the video host computing system may utilize the URL or other information associated with the request to identify the appropriate maximum time limit and/or prompt, which may be stored in the parameter storage 127.

Referring again to FIG. 2, in block 220 data for display of a video recorder, and any relevant timer and/or prompt may be transmitted to a contributor. This may be performed by the system of FIG. 1 by the video host computing system 120 transmitting the relevant data to the contributor computing system 130. In some examples, the data may be transmitted through the enterprise computing system 110 as an intermediary or if the contributor is using the enterprise computing system 110 directly, for example. A contributor may now view on a display device a video recorder window which may have controls including start, stop, pause, or the like, and may also view the prompt and a timer, if applicable.

In block 225, a request may be received to begin recording video. This may occur, for example, if a contributor presses the start button associated with the displayed video recording. In some examples, the video recorder may begin automatically once the video recorder is requested or after a predetermined delay. Referring back to FIG. 1, the request to begin recording may be made by a contributor using an input/output device of the contributor computing system 130, or in some examples, by a contributor using an input/output device of the enterprise computing system 110. For example, a contributor may touch a record button displayed on a touchscreen display associated with one of these systems, or click a record button displayed on a display device. The request may be received by the video host computing system 120, or may be received by the enterprise computing system 110 or the contributor computing system 130.

Referring again to FIG. 2, in block 230, the video recorder is operated for up to a maximum time. The video recorder may be operated by any of the computing systems shown in FIG. 1. As the recording is performed, a timer may count down from the maximum time associated with the request so that the contributor sees the amount of time remaining. In other examples, the timer may count up. The video may be received using a web cam or other video device in communication with either the contributor computing system 130 or the enterprise computing system 110 of FIG. 1. Capturing of video may stop either responsive to a contributor command to stop recording video, such as by touching or clicking a stop button, or responsive to the maximum time elapsing.

In block 235, the recorded video may be received and stored. In some examples, the video may be transmitted to the video host computing system 120 of FIG. 1 in part as it is being recorded. In other examples, the video is received by the video host computing system 120 only when the recording is complete. In some examples, a contributor may review their video and select a link or otherwise indicate their approval to submit the video to the video host computing system 120. In some examples, along with sending the video, a contributor may provide, or in some examples, may be required to enter, other information to accompany the video. The other information may include, but is not limited to, name, address, phone number, email address, race, gender, agreement to release legal rights in the recorded video, or combinations thereof. Received videos may be stored by the video host computing system 120, for example in video storage 126. In some examples, the video may be stored along with the information received from the contributor, and may also be stored along with an indication of the enterprise and/or the campaign for which it was recorded.

In block 240, an enterprise may be notified that a new video has been captured associated with their enterprise and/or a particular campaign. Referring to FIG. 1, the video host computing system 120 may notify the enterprise computing system 110 that a video has been received for their enterprise and/or a particular campaign. The notification may be implemented as an email and a notification may be sent each time a video is received, or periodically, such as every day, week, or month, for example.

In this manner, videos may be captured by any number of contributors using any number of computing systems. In examples of the invention, the captured videos may be limited in length such that the videos are less likely to require editing and more likely to contain content that is usable and advantageous to the enterprises. The computing system controlling the recording and storage of videos may be separated from the enterprise's computing system, the contributor's computing system, or both. In this manner, a store of videos which may be useful to an enterprise may be captured and stored by a computing system other than that of the enterprise.

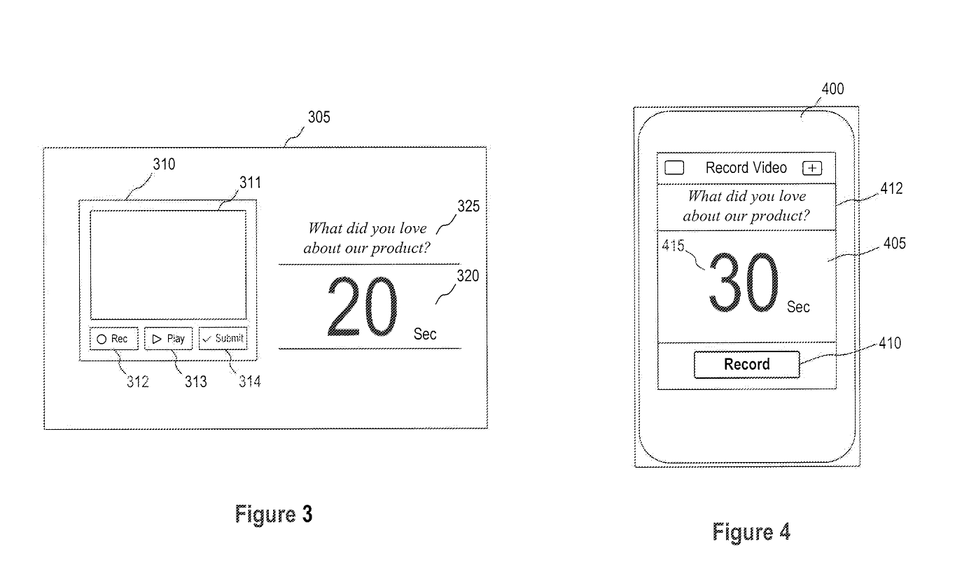

FIG. 3 is a schematic illustration of a display in accordance with an embodiment of the present invention. The display 305, may be, for example, an implementation of an input/output device 133 of the contributor computing system 130 of FIG. 1. Referring again to FIG. 3, the display 305 may present a contributor with a video recorder 310. During recording, the image being recorded may be displayed in the area 311. A record button 312, a play button 313, and a submit button 314 may be provided. These buttons may be used to capture video and submit the video to the video host computing system as described above.

As is also shown in FIG. 3, a timer 320 may be displayed. The timer may display the maximum amount of time available, and may count down as the recording proceeds. In other examples, the timer may count up, or may remain static to display a maximum time for recording. A prompt 325 is also displayed on the display 305. The prompt shown in FIG. 3 is “What did you love about our product?”, however other prompts may be used. While FIG. 3 illustrates one configuration for a display in accordance with an embodiment of the present invention, it is to be understood that the configuration of the display is flexible.

FIG. 4 is a schematic illustration of another display in accordance with an embodiment of the present invention. A mobile device 400 includes a display area 405. The display area 405 may display a video recorder, and may include a button for record 410. Only a record button is provided in the example of FIG. 4. Once the record button is activated, it may change to display a stop button or a submit button. Once the recording is stopped, a submit button may be shown. In some examples, a submit option may be presented after recording, for example, or the video may be automatically submitted during or after recording. The prompt is shown in an area 412 above a region where the image being recorded is being displayed. The timer 415 is displayed over the image being recorded.

Having described examples of methods and systems for capturing video in accordance with embodiments of the present invention, examples of methods and systems for managing videos will now be described. It is to be understood that the methods and systems for managing videos described herein may be used in combination with the methods and systems for capturing videos.

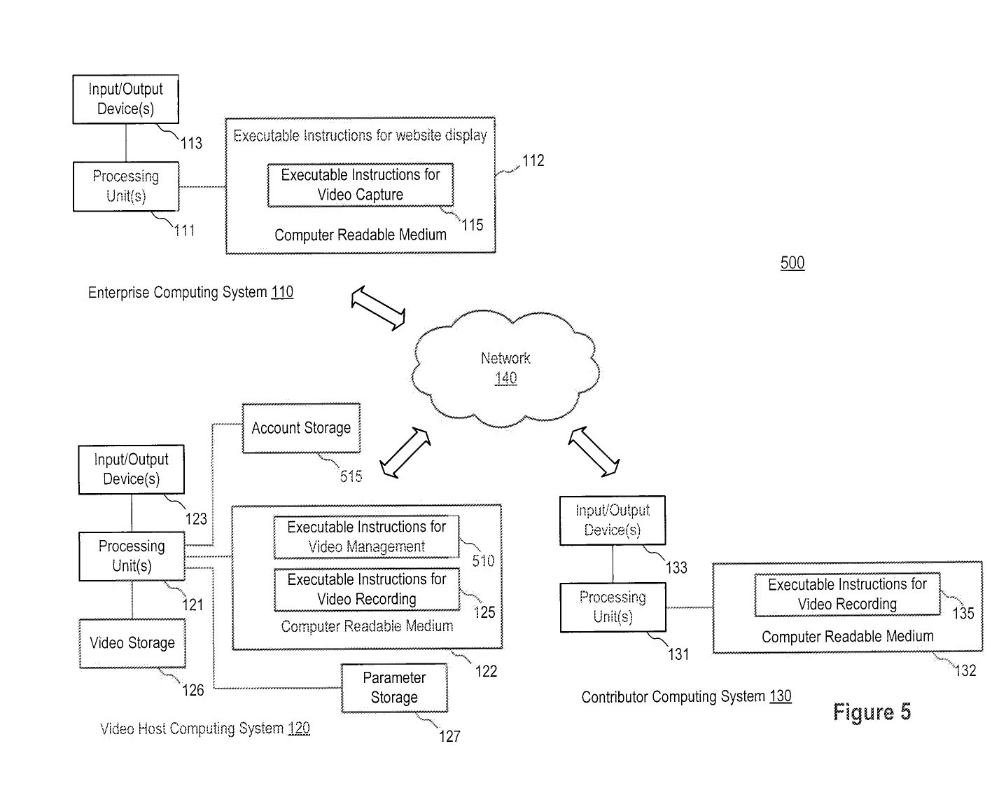

FIG. 5 is a schematic illustration of a system arranged in accordance with an embodiment of the present invention. The system 500 of FIG. 5 includes some of the same components shown in FIG. 1, with like reference numbers used. Although new components are shown additive to those in FIG. 1 to describe an example of a system that may both capture and manage videos, it is to be understood that the systems may be separated in some examples.

As shown in FIG. 5, the video host computing system 120 may include executable instructions for video management 510. The executable instructions for video management 510 may be encoded on the computer readable medium 122, or may be provided on some other computer readable medium in communication with the processing unit(s) 121. The executable instructions for video management 510 allow enterprises to establish an account with the video host computing system 120, establish one or more campaigns including one or more prompts, review and/or rate videos captured by the video host computing system 120, or combinations of these actions.

Account information may be stored in account storage 515, which may be implemented by any computer readable media in communication with the processing unit(s) 121. Although shown separately in FIG. 5, the account storage 515 may be integrated with the computer readable medium 122, the video storage 126, and/or the parameter storage 127.

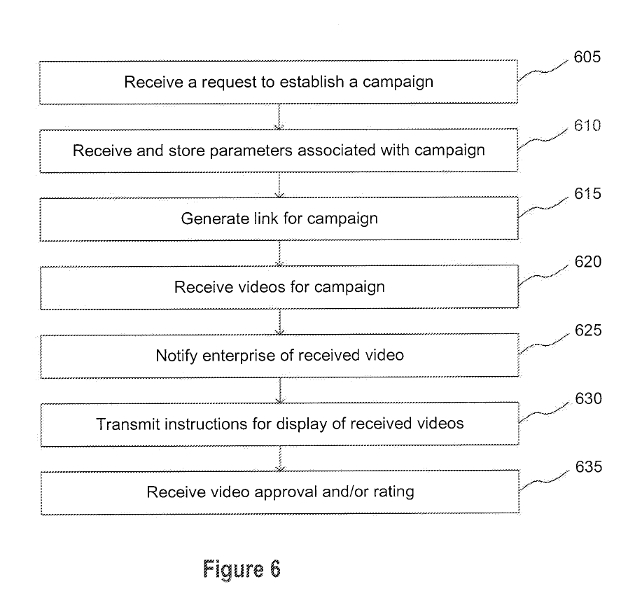

FIG. 6 is a flowchart of an example method for managing videos in accordance with an embodiment of the present invention. At block 605, a request may be received to establish a campaign. Generally, as used herein, the term campaign refers to a solicitation for videos. One enterprise may have several campaigns, such as a coffee shop having one campaign pertaining to coffee beverages and another to the cleanliness of their store. Generally, each campaign may be associated with its own prompt. Each campaign may have a unique URL or other link for submitting videos. The request may be received in block 605, for example, by the video host computing system 120 and may have been initiated by the enterprise computing system 110 of FIG. 5. In some examples, the enterprise may have first established an account including demographic or other biographical information regarding the enterprise with the video host computing system. Sending the request to establish a campaign may include logging into an account with the video host computing system 120.

Referring again to FIG. 6, in block 610 parameters associated with the campaign may be received and stored. This may be implemented, for example, by the video host computing system 120 of FIG. 5. The parameters may include, but are not limited to, a prompt for use in the campaign, a maximum time for videos to be captured in the campaign, a length of time the campaign is viable (e.g. solicit videos for one week, one month, etc.), or combinations thereof. Parameters may be stored in the parameter storage 127 in a manner indicating to which campaign they pertain for example by storing the parameters along with a campaign identifier.

In block 615 of FIG. 6, responsive to a request to create a campaign, a link may be generated for the campaign. The link may be generated by the video host computing system 120 in some examples. As was generally described above, the link may provide a unique location for contributors to go to contribute their videos for the campaign. The link may be used to direct users to a standalone site or to embed in a website or other content providing application of the enterprise. In block 620 of FIG. 6, videos for the campaign may be received, as has generally been described above, and the enterprise notified of the received video in block 625, as has also generally been described above.

An enterprise may then want to view or otherwise access submitted videos. In some examples, an enterprise may again log in to their account on the video host computing system 120 of FIG. 5. In block 630 of FIG. 6, instructions may be transmitted for display of received videos. So, for example, referring to the system 500 of FIG. 5, the video host computing system 120 may transmit instructions to the enterprise computing system 110 for display of videos received responsive to a particular campaign. A user of the enterprise computing system 110 may then view or otherwise access or review the submitted videos. The videos may be accepted or declined by the enterprise, for example, by clicking an approve or disapprove button or other interface displayed on the enterprise computing system 110. In block 635, video approval, disapproval, and/or rating may be received. Responsive to a declined video, an email or other notification may be sent to the contributor of a declined video. The email or other notification may in some examples be based upon the reason for disapproval. For example, an enterprise representative may provide an indication to the video host computing system 120 of a reason the video was disapproved—poor lighting, poor sound, or poor content, for example. The notification sent to the contributor may vary based on the reason the video was disapproved. The email or other notification may be sent by the video host computing system 120 and may be sent automatically in some examples. In some examples, a template email for decline notification may be one of the parameters associated with an enterprise and/or campaign. A number of templates may be stored, each corresponding to a different reason for refusal, in some examples. In this manner, a contributor whose video was disapproved because the lighting was poor may receive a different notification that a contributor whose video was disapproved for inappropriate content. The notification may or may not provide comments about how the contributor may revise or improve their video to result in acceptance. Videos that have been approved may then be made available for sharing, as will be described further below. The video host computing system 120 of FIG. 5 may store an indication of acceptance in the video storage 126 along with the video. In some examples, rejected videos may be deleted from the video storage 126.

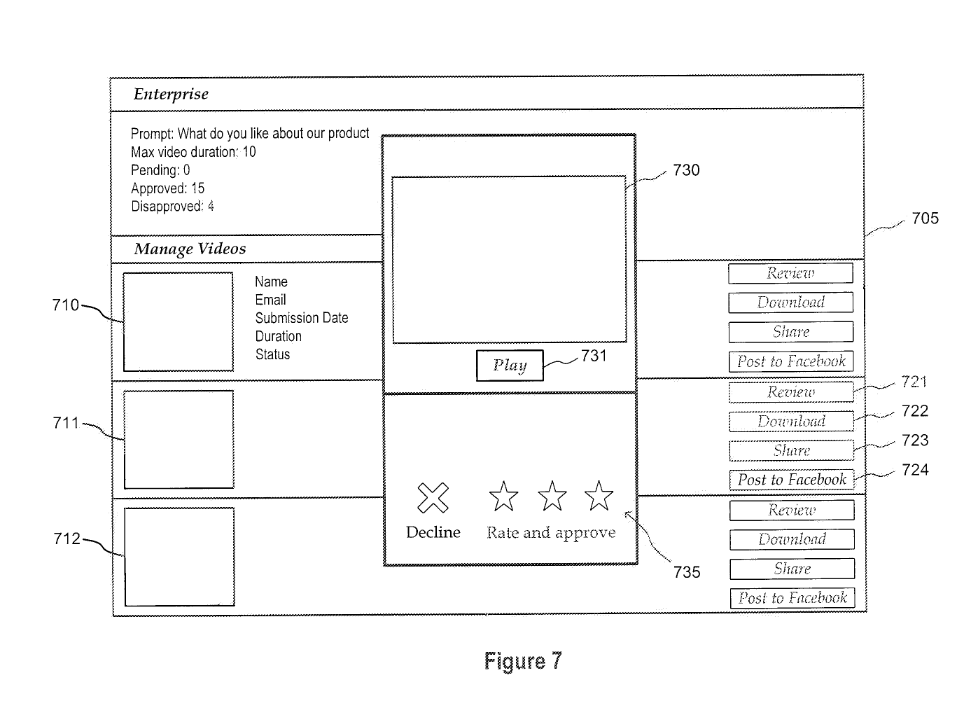

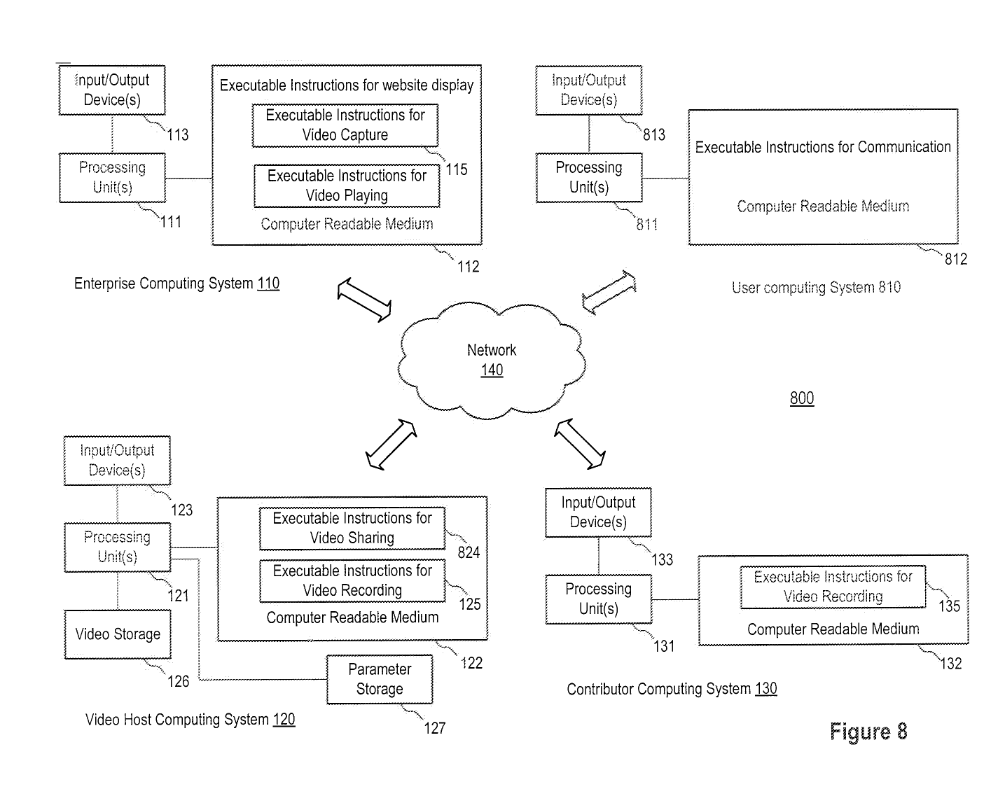

FIG. 7 is a schematic illustration of a display in accordance with an embodiment of the present invention. The display 705 may be one of the output devices 113 of the enterprise computing system 110 of FIG. 5 and the information shown in FIG. 7 may be transmitted for display by the video host computing system 120 of FIG. 5.

As shown in FIG. 7, for a particular campaign, the prompt used may be displayed, as well as any subheading used for the prompt. The maximum video duration may shown (10 seconds in the example of FIG. 7). Collected videos may be shown as well. As shown in FIG. 7, thumbnails 710, 711, 712 representing still images of captured videos are shown. For each submitted video, a name and email of the submitter may be displayed. The submission date and video duration may also be displayed. A status (such as submitted, approved, declined, shared) may also be shown.

For each submitted video, several actions may be taken using buttons shown on the right in FIG. 7. One button 721 may be “review”. Responsive to selecting the button (such as by clicking or touching the button), the video may be played for the user. Another button 722 may be ‘download’ to allow for transmission of the video from the video computing system to the enterprise computing system, for example. Another button 723 may be a ‘share’ button to allow for sharing the video to another webpage or account, such as a facebook or twitter account associated with the enterprise. A button 724 may be provided to directly share the video to a facebook fan page. In this manner, a single click (or touch in some examples) may be used to add a particular video to a facebook or YouTube channel.

If the button ‘Review’ is selected, a preview of the video may be displayed, for example, in the window 730. A play button 731 may be provided, along with data about the video (name, country, zip code, and state as shown in FIG. 7), and an interface 735 to disapprove or rate and approve the video with a selected number of stars is provided. Stars, of course, is only one example of how a rating for the video may be received. The video may also be numerically or otherwise rated by an enterprise or other user. Ratings associated with videos may be received and stored by the video host computing system and may be when sharing the videos, as will be described further below.

Having described examples of systems and methods for capturing and managing videos, examples of systems and methods for sharing videos will now be described. It is to be understood that the systems and methods for sharing videos may be used in combination with any of the systems and methods described above.

FIG. 8 is a schematic illustration of a system in accordance with an embodiment of the present invention. The system 800 may be used to share videos in accordance with embodiments of the present invention. Although portions of the system of FIG. 1 are also shown in FIG. 8, it is to be understood that the systems may be combined in some examples, and may be separate in other examples. Furthermore, in some examples components for managing videos in accordance with FIG. 5 may also be combined in the system of FIG. 8. For examples, the computer readable medium 822 of FIG. 8 may include executable instructions for video recording, video managing, and video sharing. In other examples, different computer readable media may encode those instructions but they may all be in communication with the processing unit(s) 121.

The system 800 of FIG. 8 includes a user computing system 810. The user computing system 810 may include one or more processing unit(s) 811, input/output device(s) 813 and a computer readable medium 812 encoding executable instructions for communication. The computer readable medium 812 may also encode executable instructions for display. The instructions encoded on the computer readable medium 812 may operate in cooperation with the processing unit(s) 811 to perform functionality described herein, such as to display videos on a display which may be implemented as one of the input/output device(s) 813. The computing system 810 may be implemented as any of a variety of devices including, but not limited to, server system, desktop, laptop, kiosks, mobile phone, personal digital assistant, set top box, appliance, or combinations thereof. In this manner, the user computing system 810 may be used to receive and display videos stored by the video host computing system 120. The videos may be received and displayed using communication between the user computing system 810 and the video host computing system 120 in some examples, and in some examples communication may go through the enterprise computing system 110. The video host computing system 120 may include executable instructions for video sharing 824, which may be encoded on the computer readable medium 822 or on some other computer readable media accessible to the processing unit(s) 121.

As has generally been described above, the video host computing system 120 may allow an enterprise to share a selected video or videos directly to another website or content provider associated with the enterprise. For example, a user of the enterprise computing system 110 or other representative of an enterprise may log in to the video host computing system and share captured videos on facebook, twitter, YouTube, their own enterprise website, or other content providing mechanism using a click or touch of an interface, such as that shown in FIG. 7. In particular, the executable instructions for video sharing 824 may include instructions for embedding a link to the selected video in any of the locations described above.

In other examples, a video player may be displayed for a user to view approved videos. The video player may be displayed on a stand-alone site or other content providing application, or may in some examples be embedded in an enterprise's own website or other content providing application. For example, the computer readable medium 112 (or another computer readable medium in communication with the processing unit(s) 111) may include executable instructions for video playing 840. The executable instructions for video playing 840 may be generated by the video host computing system 120 and may be particular to a specific enterprise and/or campaign in some examples. The instructions may be generated in an analogous manner to that described above for video capture, and may be generated by the processing unit(s) 121 in cooperation with the executable instructions for video sharing 824. The instructions may include, for example, instructions for an iframe on an enterprise website that may direct a user to videos hosted and played by the video host computing system 120. In one example, the executable instructions for video playing 840 may include:

<iframe src=http://watch.videogenie.com/media/embedded

Compilation.do?uid=203c5a5f-f6f3-4b61-9ff1-a93777fb8562 frame border=”0”
scrolling=”no” type=”width: 320px; height: 290px; overflow: hidden; margin: 0;”>

<a href=http://watch.videogenie.com/media/seeMoreVideos.do?uid=203c5a5f-

f6f3-4b61-9ff1-a93777fb8562 target-”_blank”>Click to see the videos.</a>

</iframe>

The code may be generated by the video host computing system 120 in accordance with the executable instructions for video sharing 824, and may be displayed or otherwise provided to the enterprise computing system 110. An administrator may in some examples cut and paste the generated code into the executable instructions for website display encoded on the computer readable medium 112. In some examples, the video host computing system 120 may automatically insert the code into code of the enterprise computing system 110.

In this manner, a user viewing a website hosted by the enterprise computing system 110 may view a video player hosted and displayed by the video host computing system 120. The videos played by the video player may be selected by the video host computing system 120 in accordance with the executable instructions for video sharing 824. The particular video played, and/or an order in which videos are played or an order in which videos are displayed for playback by a user, may be selected by the video host computing system 120 in accordance with the executable instructions for video sharing 824.

Videos may be selected in any of a variety of ways by the video host computing system 120 in accordance with the executable instructions for video sharing. In some examples, a video to play first, or an order of video playback may be selected prior to receipt of a request from a user. In other examples, the order is determined after receipt of a user request, and may be based on characteristics of the user and/or the request.

In some examples, the executable instructions for video sharing 824 may include instructions for recording a number of views each video has received. The number of views may be stored, for example, in the parameters storage 127 or other storage accessible to the processing unit(s). Other information regarding a video may also be stored including but not limited to, the number of likes or other hits the video has received, the length of time a user remains on a site following the video, a number of conversion events occurring after the video is viewed, or combinations thereof. Videos may be selected for playback or display in an order that may be based on this information. For example, videos which were viewed more frequently may be more likely to be selected for playback or may be displayed higher on a list of displayed videos for selection by a user. In some examples, the video host computing system 120 may track this information for particular geographical regions or demographic populations. So, for example, the executable instructions for video sharing 824 may include instructions for recording and storing views of a video or any of the other information described above, and may also record and store a location or demographic information about the viewer, which may be provided along with a request to view the video. The executable instructions for video sharing 824 may further include instructions for selecting a video to playback or selecting an order of displayed videos based on the recorded information, including video view counts, geography, and demographic information.

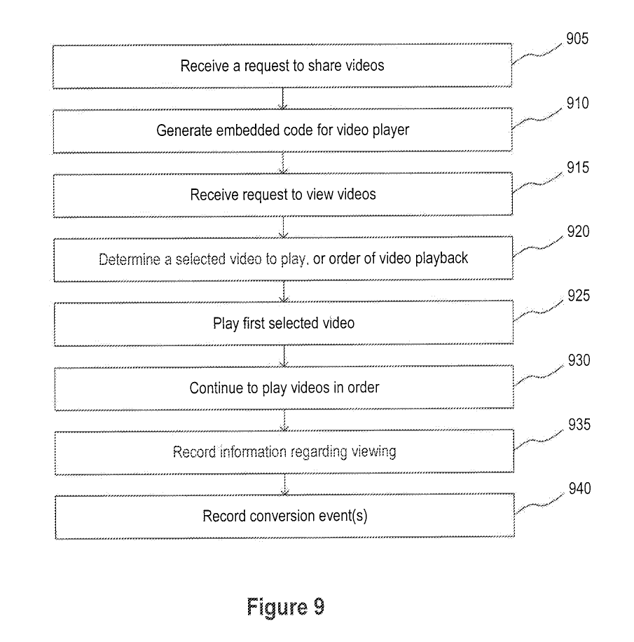

FIG. 9 is a flowchart of an example method for sharing videos in accordance with an embodiment of the present invention. The executable instructions for video sharing 824 of FIG. 8 may include instructions for performing some or all of the steps shown in FIG. 9. In block 905 of FIG. 9, a request may be received to share videos. The request may come from the enterprise computing system 110 shown in FIG. 5 or 8, for example. When logging in to manage an enterprise's video for example, an enterprise user may elect to share a particular video or a group of videos, such as by approving the videos or otherwise indicating the videos should be shared. In some examples, in response to the request to share the video, referring to FIG. 9, embedded code for a video player may be generated in block 910. In other examples, the video may be directly shared to facebook, twitter, or some other content sharing application.

In block 910, embedded code for a video player may be generated. As was mentioned above, the embedded code may be generated by the video host computing system 120 of FIG. 8 and may be embedded in code of an enterprise in the enterprise computing system 110. In block 915, a request may be received to view videos. The request may be received, for example by an end user, such as a user of the user computing system of 810. The user of the user computing system 810 may view a website hosted by the enterprise computing system 110 and may thereby request one or more videos for playback.

Referring again to FIG. 9, in block 920, a selected video, or order of video playback or video display may be determined. The determination may be made by the video host computing system as described above and may be made before or after receipt of the request to view videos. When made after the request to view videos, the selection of video or order of videos may be made based on information about the request or requestor, such as geographical or demographic information. The order of video playback, or an order in which videos are displayed for user selection, may be determined based on which videos have been viewed the most (e.g. click-through rate, a percentage or number of visitors who click on or otherwise request the content of the video), which videos have been abandoned the most (e.g. abandonment rate, a percentage or number of visitors who stop or otherwise abandon the video prior to completion), which ones have resulted in the greatest number of conversion events (e.g. conversion rate, a percentage or number of visitors who have a conversion event following viewing the video), or which ones generate the most referrals (e.g. referral rate, a percentage or number of visitors who refer others to the video), “like” rate (e.g. percentage or number of viewers who “like” the video on Facebook or another site), or combinations thereof in some examples. The aforementioned rates and statistics may be gathered and stored by the video host computing system. As was mentioned above, a conversion event may include, for example, signing up for a newsletter or other promotional mailing, buying a product, or otherwise positively interacting with the enterprise. In other examples, the video order may also be determined based on how new the video is (e.g. fresher videos may be ordered higher), how long the video is (e.g. in some examples a long video may be followed by a short video to maintain viewer interest), an audio level of the video (e.g. in some examples a quiet video may be followed by a loud video or vice versa to maintain viewer interest), a light level of the video (e.g. a dark video may be followed by a light video in some examples to maintain viewer interest), a demographic characteristic of the contributor (e.g. a similar age or gender to the requestor may be selected), or combinations thereof.

In block 925, the first selected video may be played. The video may be transmitted from the video host computing system to a user computing system, in some examples the video may be transmitted from the video host computing system through the enterprise computing system to the user computing system. The first video may be a first video automatically played as selected by the video host computing system, or may be a first video selected by a user in response to a display of a selection of videos. The selection of videos may have been ordered in a manner selected by the video host computing system as generally described above.

In block 930, the videos may continue to play. In some examples, the videos are played automatically in an order determined by the video host computing system. In other examples, the videos are played in an order as indicated by a user. However, the videos may have been displayed for selection in a particular order selected by the video host computing system.

In block 935, information regarding the viewing of videos may be recorded. The information may be stored, for example, by the video host computing system 120 and/or the enterprise computing system 110. In some examples, the number of videos viewed and/or the order in which they were viewed may be stored by the video host computing system. The number of views and order of views may be used by the video host computing system 120 to determine the order of display or playback responsive to future requests for videos for that enterprise or campaign.

In block 940, conversion events may be recorded. For example, the video host computing system 120 may receive and store information regarding conversion events made by users who viewed one or more videos. The conversion information may be obtained in any of a variety of ways. In some examples, conversion tracker code may be installed on the enterprise computing system 110, for example by being stored on the computer readable medium 112. The conversion tracker code may be generated by the video host computing system 120 and may be particular to an enterprise and/or a campaign. The conversion tracking code may generally be used on a page or other content that is indicative of a conversion event, such as a page or content visible to a user following making a purchase or registering for a newsletter or account. One example of a particular conversion tracker code is <iframe src=http://watch.videogenie.com/media/conversion.do?uid=123A45B6789C00D12Estyle=“position: absolute;top:0; left:1000px; width:300px; height:100px”></iframe>.

In this manner, when a user performs a conversion event, the conversion tracking code may transmit a conversion indication to the video host computing system 120. The video host computing system 120 may store an indication of the conversion associated with any videos the user may have viewed prior to the conversion event.

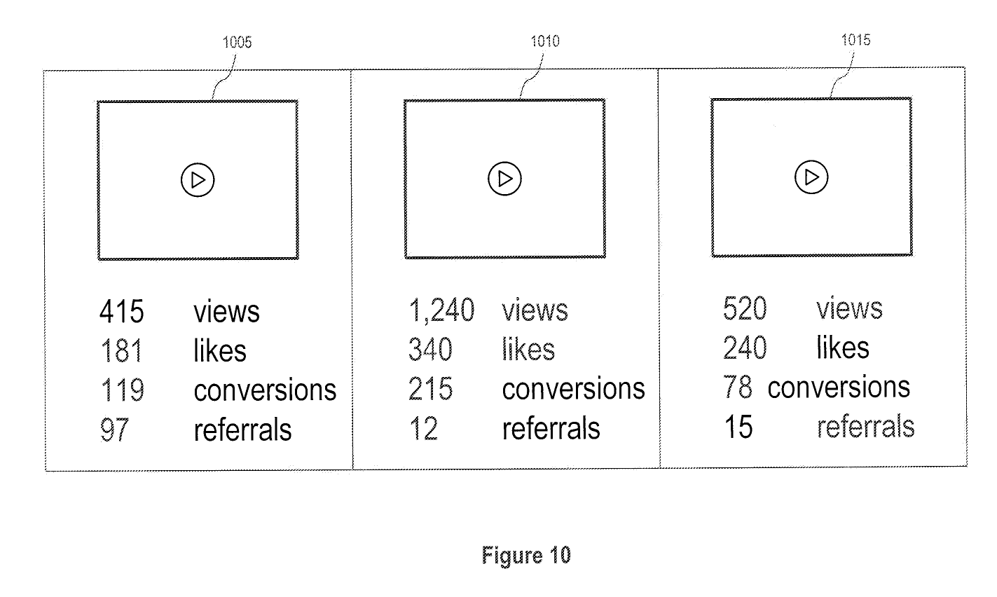

FIG. 10 is a schematic illustration of information associated with videos which may be stored in examples of the present invention. In some examples, the information shown in FIG. 10 may be displayed on a display device, such as an output device 113 of the enterprise computing system 110 of FIG. 8. In other examples, the information shown may not be displayed. In some examples, the information shown in FIG. 10 may be gathered by the video host computing system 120 of FIG. 8 and may be stored, for example in video and/or parameter storage 126 and 127.

Referring to FIG. 10, three videos are shown, videos 1005, 1010, and 1015. The video 1005 has been viewed 415 times, has been “liked” or otherwise positively rated by users 181 times, has preceded 119 conversion events, and has generated 97 referrals. The video 1010 has been viewed 1,240 times, has been “liked” or otherwise positively rated by users 340 times, has preceded 215 conversion events, and has generated 12 referrals. The video 1015 has been viewed 520 times, has been “liked” or otherwise positively rated by users 240 times, has preceded 78 conversion events, and has generated 15 referrals.

In some examples, the information shown in FIG. 10 may result in the video host computing system being more likely to display the particular video for playback. For example, the video host computing system may be more likely to display the video 1010, or to display the video 1010 more prominently, because it has generated a greater number of views, likes, and conversions. In some examples, the number of referrals may be used for enterprises to contact the video contributor or otherwise utilize the video contributor in their campaigns. For example, the video 1005 of FIG. 10 had generated the greatest number of referrals. That is, the contributor of the video 1005 may have been provided with a link or other mechanism to notify friends or connections of his video. The referral number may correspond to a number of users who viewed an enterprise site on the basis of the contributor's video. An enterprise may identify these key referral contributors and may target them for future advertising or use in future campaigns.

From the foregoing it will be appreciated that, although specific embodiments of the invention have been described herein for purposes of illustration, various modifications may be made without deviating from the spirit and scope of the invention.

What is claimed is:

1. A method for sharing videos, the method comprising:
storing a plurality of captured videos at a first computing system, wherein each of the plurality of captured videos have a limited duration;
receiving a request for playback of captured videos from a second computing system; and
transmitting information for display of ones of the plurality of captured videos for playback, wherein an order of the display of ones of the plurality of captured videos for playback is based, at least in part on one of a number of previous views or a number of conversion events following previous views of the ones of the plurality of captured videos.

2. The method of claim 1, wherein the limited duration is less than 30 seconds.

3. The method of claim 1, wherein said receiving a request for playback including receiving demographic or geographic information associated with a requestor, and wherein the order of the display is further based, at least in part, on the demographic or geographic information.

4. The method of claim 1, further comprising playing the ones of the plurality of captured videos; and
recording information regarding the viewing of the ones of the plurality of captured videos.

5. The method of claim 4, further comprising storing, at the first computing system, information regarding a conversion event performed, at least in part, at the second computing system.

6. The method of claim 5, further comprising receiving information regarding the conversion event from the second computing system through embedded executable instructions in a website hosted by the second computing system.

7. The method of claim 1, wherein the captured videos were captured responsive to a campaign associated with a prompt, and wherein said receiving a request is associated with the campaign.

8. A non-transitory computer readable medium encoded with executable instructions, including instructions for:
recording video from a computing system, wherein the video is recorded for a predetermined maximum duration, and wherein the video is recorded responsive to a campaign including a prompt;
storing a plurality of recorded videos associated with the campaign;
receiving a ranking of ones of the plurality of recorded videos from an enterprise sponsoring the campaign;
receiving a request to display videos;
displaying ones of the plurality of recorded videos in an order based, at least in part, on the ranking of the ones of the plurality of recorded videos.

9. The non-transitory computer readable medium of claim 8, wherein the predetermined maximum duration is 30 seconds or less.

10. The non-transitory computer readable medium of claim 8, wherein the predetermined maximum duration is specified by the enterprise.

11. The non-transitory computer readable medium of claim 8, wherein the order is further based, at least in part, on a number of previous views of ones of the plurality of recorded videos.

12. The non-transitory computer readable medium of claim 8, wherein the request to display videos is received from a computing system associated with the enterprise.

13. The non-transitory computer readable medium of claim 8 further including instructions for displaying a timer during recording of the video.

14. The non-transitory computer readable medium of claim 13 wherein the timer is configured to count down from the maximum duration.

15. A method for promoting conversion events using videos, the method comprising:
establishing a campaign by opening an account at a video host computing system and transmitting a prompt associated with the campaign;
receiving first embedded code for directing contributors to a video recorder;
embedding, at an enterprise computing system, the first embedded code in a content application;
reviewing videos recorded responsive to the prompt, wherein the videos are stored at the video host computing system, and approving ones of the videos;
receiving, from the video host computing system, second embedded code for displaying the approved ones of the videos;
embedding the second embedded code in the content application, wherein the second embedded code is configured to display videos in an order determined, at least in part, by a number of previous views of each of the videos.

16. The method of claim 15, wherein the first embedded code comprises an html iframe.

17. The method of claim 15, wherein the second embedded code comprises an html iframe.

18. The method of claim 15, wherein the videos recorded responsive to a prompt are 30 seconds or less in duration.

19. The method of claim 15, wherein the first embedded code is configured to direct video contributors to the video host computing system.

20. The method of claim 15, wherein the second embedded code is configured to display videos from the video host computing system.
